(19) United States
(12) Patent Application Publication
(10) Pub. No.: US 2006/0200482 A1
(43) Pub. Date: Sep. 7, 2006

(54) System, Method and Program Product for Setting and Managing Breakpoints in a Data Schema Mapping Editor

(75) Inventor: Shu Xia Tan, Toronto, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/906,785

(22) Filed: Mar. 7, 2005

(51) Int. Cl. G06F 7/00

(52) U.S. Cl. 707/102

(57) ABSTRACT

Breakpoints are set in a data schema mapping editor that has an expandable view of model objects. A vertical ruler is provided adjacent to the expandable view for setting breakpoints for the model objects. If the expandable view is manipulated or if a scroll bar is adjusted, the breakpoints will be reset along the vertical ruler as needed. In addition, identifiers will be assigned to each breakpoint based on their associated model objects. The identifiers will also be reassigned, as necessary, to accommodate the addition or deletion of model objects from the expandable view. A “recovery” mechanism also determines when a new model object is actually a previously deleted model object.

The present invention generally relates to source code development and debugging. Specifically, the present invention relates to the setting and managing of breakpoints in a data schema mapping editor having an expandable view.

### RELATED ART

In the field of source code development, Integrated Development Environments (IDEs) are often utilized. Many IDEs such as ECLIPSE implement some type of source code editor so that source code can be viewed during debugging. In utilizing a source code editor, developers often desire to set marks or breakpoints next to certain lines or units of source code. In most editors, setting/deleting, enabling, or disabling a breakpoint is a relatively easy process driven by an input device such as a mouse or the like.

Although various types of editors exist, one currently implemented is a mapping editor. Referring to FIG. 1, an illustrative mapping editor 10 is shown. As depicted, mapping editor includes an expandable view 12 (e.g., a tree view or a table tree view) of model objects 14. Expandable view 12 is typically a hierarchical structure in which each model object 14 represents one node. A developer will develop and/or debug source code by graphically dragging and dropping model objects 14 into the mapping. As such, each model object typically corresponds to a unit of source code. With such a capability, the developer need not write the actual source code. Rather, the developer can simply insert or remove model objects 14 that were previously written.

Unfortunately, with a mapping editor such as that shown in FIG. 1, setting breakpoints is a challenge. For example, there is currently no location in mapping editor 10 in which breakpoints for model objects 14 can be set. Moreover, given the way in which expandable view 12 can be manipulated (e.g., expanded or collapsed), no current system provides a way to reset the breakpoints as needed. The same shortcoming holds true when scroll bar 16 is adjusted. Still yet, no current system addresses the issue of assigning identifiers to breakpoints based on the model objects with which they are associated. To this extent, no existing system addresses the various issues that arise when model objects 14 are added or deleted from expandable view 12.

In view of the foregoing, there exists a need for a system, method and program product for setting and managing breakpoints in a data schema mapping editor having an expandable view. Specifically, a need exists for a system in which breakpoints can be set and reset as needed within the data schema mapping editor. A further need exists for the system to provide a mechanism for assigning identifiers to any breakpoints that are set, and for re-assigning identifiers as model objects are added or deleted from the expandable view. Still yet, a need exists for the system to provide a breakpoint recovery mechanism for when a previously deleted model object is re-added to the expandable view.

### SUMMARY OF THE INVENTION

In general, the present invention provides a system, method and program product for setting and managing breakpoints in a data schema mapping editor having an expandable view of model objects. Specifically, under the present invention, a vertical ruler is provided adjacent to the expandable view for setting breakpoints for the model objects. If the expandable view is manipulated or if a scroll bar adjusted, the present invention will reset the breakpoints along the vertical ruler as needed. In addition, the present invention will assign identifiers to each breakpoint based on their associated model objects. The identifiers will also be reassigned, as necessary, to accommodate the addition or deletion of model objects from the expandable view. Still yet, the present invention provides a “recovery” mechanism for determining when a new model object is actually a previously deleted model object.

A first aspect of the present invention provides a data schema mapping editor comprising: an expandable view of model objects, wherein each of the model objects corresponds to a unit of source code; and a vertical ruler associated with the expandable view for setting breakpoints for the model objects.

A second aspect of the present invention provides a method for generating a data schema mapping editor, comprising: generating an expandable view of model objects in the data schema mapping editor, wherein each of the model objects correspond to a unit of source code; and positioning a vertical ruler for setting breakpoints for the model objects adjacent to the expandable view.

A third aspect of the present invention provides a system for setting breakpoints in a data schema mapping editor, comprising: a breakpoint setting system for setting the breakpoints along a vertical ruler associated with an expandable view of model objects in the data schema mapping editor; a view listener for resetting the breakpoints based on a manipulation of the expandable view; a selection listener for resetting the breakpoints based on a manual adjustment of a scroll bar associated with the expandable view; and a content listener for resetting the breakpoints based on an automatic adjustment of the scroll bar.

A fourth aspect of the present invention provides a program product stored on a recordable medium for setting breakpoints in a data schema mapping editor, which when executed, comprises: program code for setting breakpoints along a vertical ruler associated with an expandable view of model objects in a data schema mapping editor; program code for resetting the breakpoints based on a manipulation of the expandable view; program code for resetting the breakpoints based on a manual adjustment of a scroll bar associated with the expandable view; and program code for resetting the breakpoints based on an automatic adjustment of the scroll bar.

A fifth aspect of the present invention provides a method for recovering breakpoints in a data schema mapping editor, comprising: receiving a command to delete a model object from an expandable view in the data schema mapping editor; determining whether the model object has a breakpoint on a vertical ruler associated with the expandable view; and if the model object has the breakpoint, storing information corresponding to the breakpoint in a cache, storing an identifier associated with the breakpoint in a predetermined field of the model object, and deleting the breakpoint from the vertical ruler.

A sixth aspect of the present invention provides a system for recovering breakpoints in a data schema mapping editor, comprising: means for receiving a command to delete a model object from an expandable view in the data schema mapping editor; means for determining whether the model object has a breakpoint on a vertical ruler associated with the expandable view; means for storing information corresponding to the breakpoint in a cache, and for storing an identifier associated with the breakpoint in a predetermined field of the model object if the model object has the breakpoint; and means for deleting the breakpoint from the vertical ruler.

A seventh aspect of the present invention provides a method for deploying an application for setting breakpoints in a data schema mapping editor, comprising: providing a computer infrastructure being operable to: set breakpoints along a vertical ruler associated with an expandable view of model objects in a data schema mapping editor; reset the breakpoints based on a manipulation of the expandable view; reset the breakpoints based on a manual adjustment of a scroll bar associated with the expandable view; and reset the breakpoints based on an automatic adjustment of the scroll bar.

An eighth aspect of the present invention provides computer software embodied in a propagated signal for setting breakpoints in a data schema mapping editor, the computer software comprising instructions to cause a computer system to perform the following functions: set breakpoints along a vertical ruler associated with an expandable view of model objects in a data schema mapping editor; reset the breakpoints based on a manipulation of the expandable view; reset the breakpoints based on a manual adjustment of a scroll bar associated with the expandable view; and reset the breakpoints based on an automatic adjustment of the scroll bar.

Therefore, the present invention provides a system, method and program product for setting and managing breakpoints in a data schema mapping editor having an expandable view of model objects.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a data schema mapping editor according to the prior art.

FIG. 2 depicts a system for setting breakpoints in a data schema mapping editor according to the present invention.

FIG. 3 depicts the mapping system of FIG. 2 in greater detail.

FIG. 4 depicts an illustrative data schema mapping editor according to the present invention.

FIG. 5 depicts the data schema mapping editor of FIG. 4 after illustrative breakpoints have been set.

FIG. 6 depicts the resetting of breakpoints of the data schema mapping editor of FIG. 5.

FIG. 7 depicts a UML diagram for implementing the present invention.

FIG. 8A depicts the assignment of identifiers to nodes/model objects according to the present invention.

FIG. 8B depicts the re-assignment of identifiers to nodes/model objects according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a system, method and program product for setting and managing breakpoints in a data schema mapping editor having an expandable view of model objects. Specifically, under the present invention, a vertical ruler is provided adjacent to the expandable view for setting breakpoints for the model objects. If the expandable view is manipulated or if a scroll bar adjusted, the present invention will reset the breakpoints along the vertical ruler as needed. In addition, the present invention will assign identifiers to each breakpoint based on their associated model objects. The identifiers will also be reassigned, as necessary, to accommodate the addition or deletion of model objects from the expandable view. Still yet, the present invention provides a breakpoint “recovery” mechanism for determining when a new model object is actually a previously deleted model object.

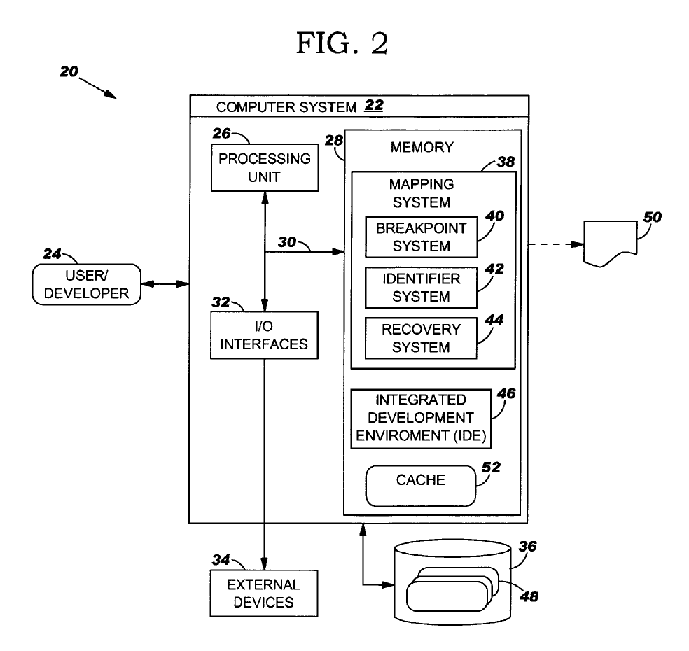

Referring now to FIG. 2, an illustrative system 20 for setting and managing breakpoints in a data schema mapping editor having an expandable view of model objects according to the present invention is shown. As shown, system 20 depicts user/developer 24 in communication with computer system 22, which is intended to represent any type of computer system capable of carrying out the teachings of the present invention. For example, computer system 22 could be a desktop computer, a laptop computer, a workstation, a hand held device, a client, a server, etc.

In any event, computer system 20 includes processing unit 26, memory 28, bus 30, input/output (I/O) interfaces 32, external devices/resources 34 and storage unit 36. Processing unit 26 may comprise a single processing unit, or be distributed across one or more processing units in one or more locations, e.g., on a client and server. Memory 28 may comprise any known type of data storage and/or transmission media, including magnetic media, optical media, random access memory (RAM), read-only memory (ROM), a data cache, a data object, etc. Moreover, similar to processing unit 26, memory 28 may reside at a single physical location, comprising one or more types of data storage, or be distributed across a plurality of physical systems in various forms.

I/O interfaces 32 may comprise any system for exchanging information to/from an external source. External devices/resources 34 may comprise any known type of external device, including speakers, a CRT, LED screen, hand-held device, keyboard, mouse, voice recognition system, speech output system, printer, monitor/display, facsimile, pager, etc. Bus 30 provides a communication link between each of the components in computer system 22 and likewise may comprise any known type of transmission link, including electrical, optical, wireless, etc.

Storage unit 36 can be any system (e.g., a database, etc.) capable of providing storage for information under the present invention. Such information could include, for example, units of source code 48. As such, storage unit 30 could include one or more storage devices, such as a magnetic disk drive or an optical disk drive. In another embodiment, storage unit 30 includes data distributed across, for example, a local area network (LAN), wide area network (WAN) or a storage area network (SAN) (not shown). Although not shown, additional components, such as communication systems, system software, etc., may be incorporated into computer system 22.

It should be appreciated that the teachings of the present invention could be implemented on a standalone computer system 22 as shown, or over a network, which can be any type of network such as the Internet, a local area network (LAN), a wide area network (WAN), a virtual private network (VPN), etc. In the case of the latter, communication throughout the network could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Still yet, connectivity could be provided by conventional IP-based protocol. In this instance, an Internet service provider could be used to establish interconnectivity.

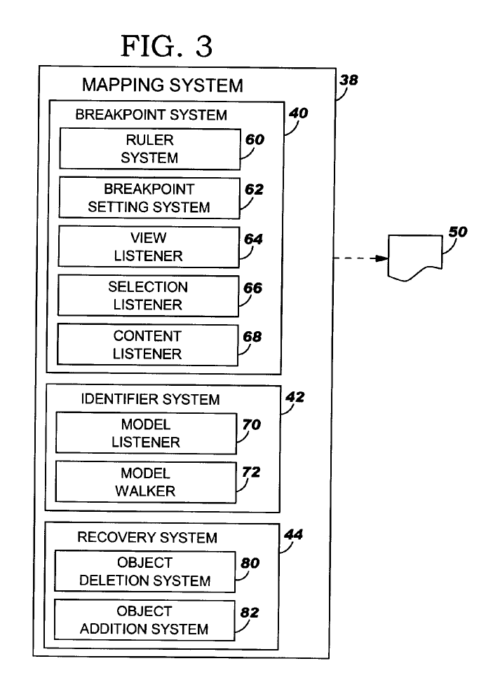

Shown in memory 28 of computer system 22 as a program product is mapping system 38 and Integrated Development Environment (IDE 46). Also shown is cache (memory) 52. IDE 46 can be any type of IDE now known or later developed. For example, IDE 46 can be ECLIPSE. Moreover, it should be understood that mapping system 38 could be implemented as a plug-in or the like to IDE 46. As depicted, mapping system 38 generally includes one or more breakpoint system 40, identifier system 42 and recovery system 44. Each of these systems 40, 42 and 44 themselves include components or subsystems that are more specifically shown in FIG. 3. These systems 40, 42 and 44 will be specifically described in sections A-C below.

Breakpoint System

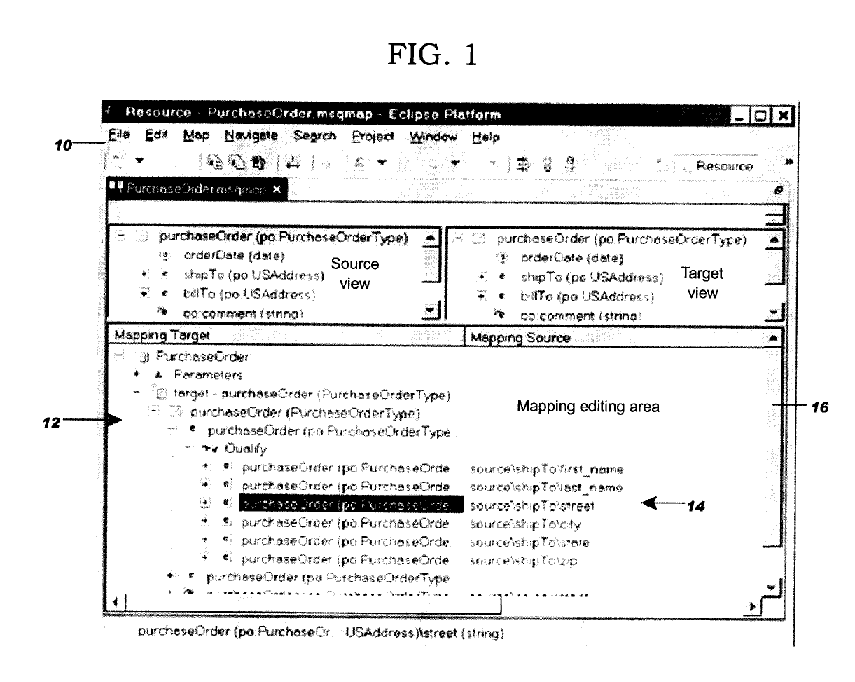

Turning specifically, to FIG. 3 the functions of breakpoint system 40 of mapping system 38 will be more specifically described. As indicated above, various IDEs utilize some type of source code editors that allow developers to develop and/or debug a computer program. The type of editor discussed above in conjunction with in FIG. 1 is a mapping editor having an expandable view. However, as indicated above, with such an editor, implementing breakpoints is a challenge. To this extent, the present invention provides breakpoint system 40. As shown, breakpoint system 40 includes ruler system 60, breakpoint setting system 62, view listener 64, selection listener 66 and content listener 68. Under the present invention, ruler system 60 will first modify a data schema mapping editor to include a vertical rule on which breakpoints can be set and/or indications thereof displayed.

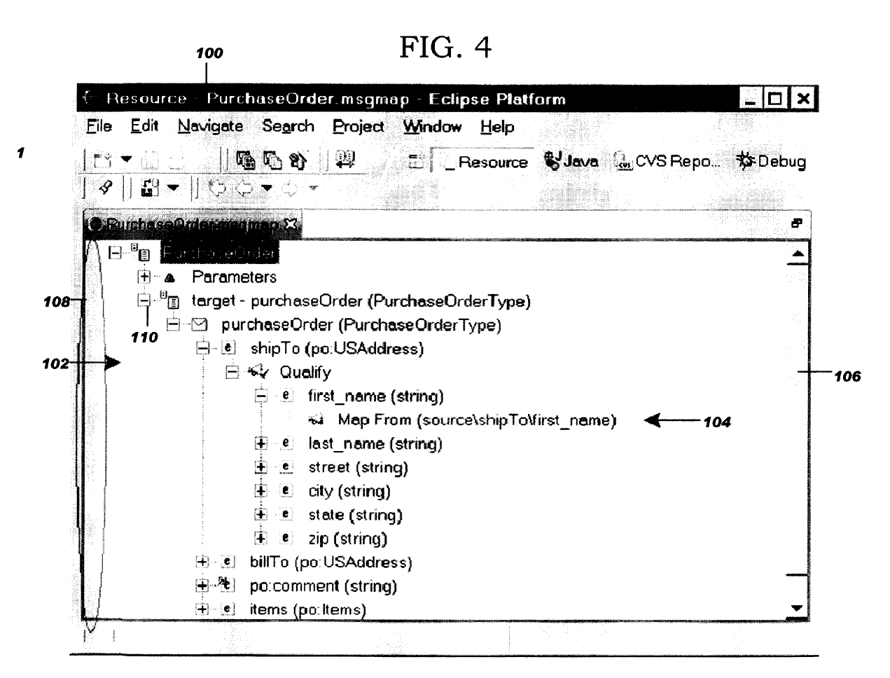

Referring to FIG. 4, an illustrative data schema mapping editor (hereinafter editor 100) according to the present invention is shown. As shown, editor 100 includes an expandable view 102 (e.g., a tree view or a table tree view) of model objects (also referred to as map commands or map objects) 104. Each model object 104 typically represents a unit of source code. Illustrative model objects 104 shown in FIG. 4 include, among others, “shipTo” and billTo.” User 24 (FIG. 2) can add or remove model objects 104 to/from expandable view 102 using any known technique such as dragging and dropping using a pointer device. Moreover, as known, expandable view 102 can be manipulated by interacting with an expansion or collapse icon such as icon 110. In general, expandable view 102 is a hierarchical structure in which each model object 104 represents a node. For example, the “Qualify” model object/node is a child of the “shipTo” model object/node.

In any event, under the present invention ruler system 60 (FIG. 3) augments the generation of editor 100 by inserting a vertical ruler 108, which is used for setting breakpoints for model objects 104. Specifically, since editor 100 include vertical ruler 108, breakpoint setting system 62 (FIG. 3) can be used to set breakpoints. In a typical embodiment, the operations supported by breakpoint setting system 62 include setting, removing, enabling and disabling breakpoints. To set a breakpoint, user 24 (FIG. 2) can “double-click” a position on vertical ruler 108. The breakpoint will then be set for the model object 104 corresponding to that position, and will be drawn on that position on vertical ruler 108. Another way of setting a breakpoint is for user 24 “right-click” on the vertical ruler 108 which position corresponds to model object 104, and the select a “set breakpoint” option from a popup menu.

Removing a breakpoint can be performed similarly. For example, user 24 can “double-click” on the breakpoint. The breakpoint will then be removed for the model object 104 corresponding to that position. Another way of removing a breakpoint is for user 24 to “right-click” on the vertical ruler 108 which position corresponds to model object 104, and then select a “remove breakpoint” option from a popup menu.

To disable or enable breakpoint, user 24 can “right-click” on the breakpoint and select a “disable breakpoint” or an “enable breakpoint” option from a pop-up menu. At that point, the breakpoint will be disabled or enabled for the model object 104 corresponding to that position. Another way to disable or enable a breakpoint is for user 24 to right-click on the vertical ruler 108 which position corresponds to model object 104 and then select a “disable breakpoint” or an “enable breakpoint” from a popup menu.

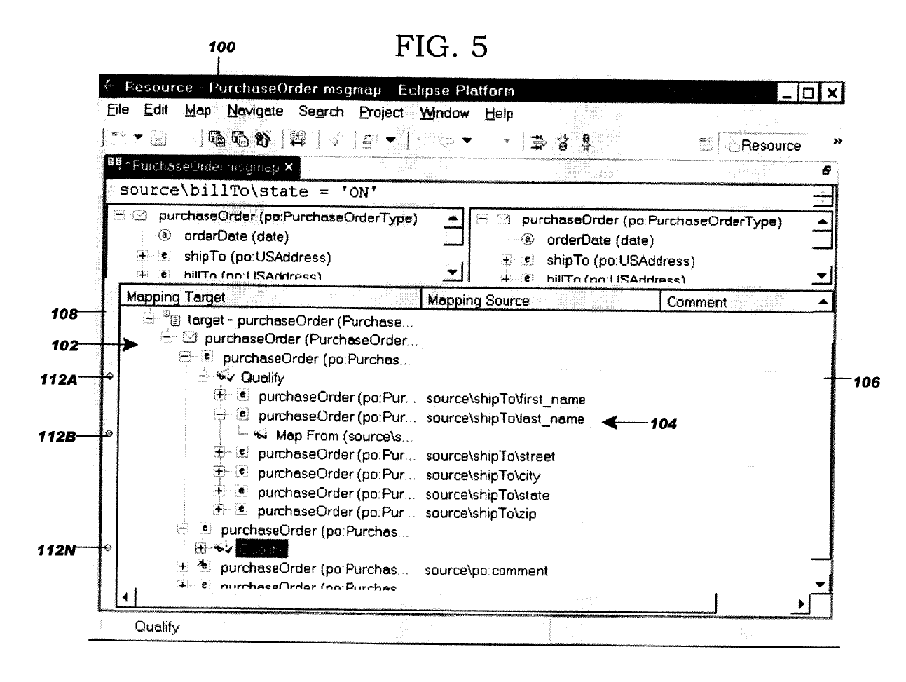

If user 24 performs any of these functions, breakpoint setting system 62 (FIG. 3) will implement the necessary action along vertical ruler 108. As breakpoints are set and deleted, they will be added to and deleted from a (manager's) list 50 (FIGS. 2 and 3), accordingly. Referring now to FIG. 5, editor 100 is shown after breakpoints 112A-N have been set. As depicted, user 24 (FIG. 2) has set breakpoints 112A-N for the “Qualify,” Map From (source\s . . . ” and “Qualify” model objects 104. If user 24 deletes, enables or disables breakpoints 112A-N, breakpoint setting system 60 will take the corresponding action.

Unlike breakpoints in a Java source editor or a C/C++ source editor, the expandable view 102 editor 100 can be manipulated (e.g., expanded and collapsed). As such, breakpoints 112A-N on vertical ruler 108 should be reset/updated accordingly. Under the present invention, when expandable view 102 is expanded, any breakpoints on the sub-tree of the selected/expanded model object will be shown on the vertical ruler 108. Conversely, when expandable view 102 is collapsed, breakpoints on the sub-tree of the selected/collapsed model object will be hidden from the user 24.

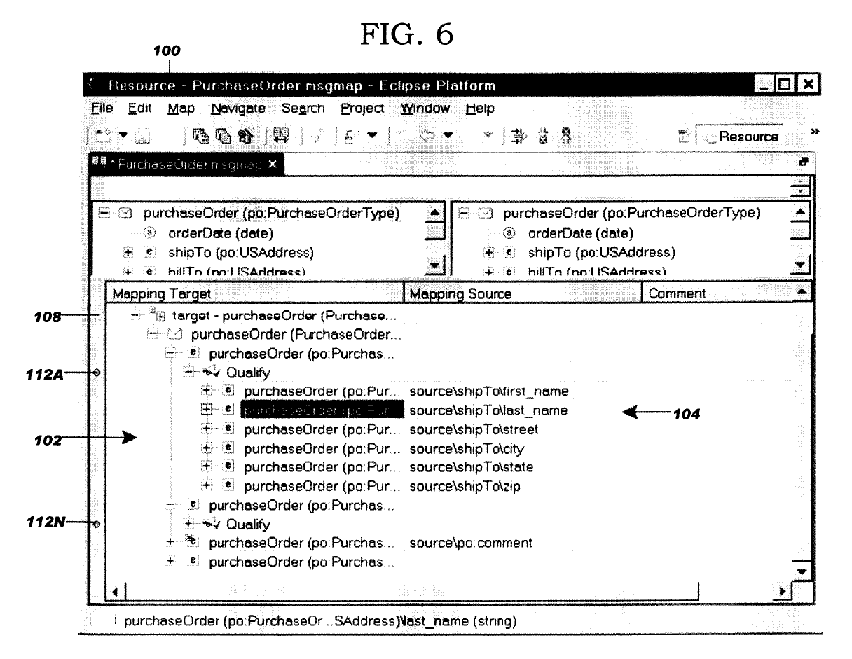

To this extent, the present invention provides (tree) view listener 64 (FIG. 3) that is used to “listen” to manipulation (e.g., expansion and collapsing) events of expandable view 102. Specifically, whenever view listener 64 detects an event, it will check the breakpoints and inform breakpoint setting system 62, which will reset the same to hide or to expose them. Referring now to FIG. 6, editor 100 is shown after expandable view has been manipulated. Specifically, the highlighted model object 104 has been collapsed, thus hiding its children (FIG. 5). When such an event occurs, it will be detected by view listener 64, which will then determine that breakpoint 112B should be hidden. The operation of hiding breakpoint 112B can be carried out by breakpoint setting system 62 or view listener 64.

When the expandable view 102 is not expanded so that all the contents in the client area of the expandable view 102 can be displayed, scroll bar 106 can be displayed (e.g., along the right side of the expandable view 102). Scroll bar 106 helps the user 24 to browse contents of the expandable view 102. According to the scroll bar 106's position, the content in visible area will be changed. As such, the breakpoints 112A-N on the vertical ruler 108 should also be moved up or down. To be able to reset the breakpoints 112A-N as needed, the vertical ruler 108 needs to “know” the new position of each breakpoint. This position can be determined and revised from the position of the scroll bar 106. However, unlike a text editor, for expandable view 102, there are multiple ways that position of scroll bar 106 could be changed. One way is that scroll bar 106 can be manually adjusted by user 24 via a pointer device or the keyboard. Another way is that scroll bar 106 can be adjusted automatically according to the size of expandable view 102 when expandable view 102 is expanded or collapsed.

When scroll bar 106 is manually adjusted, selection listener 66 (FIG. 3) listens/detects the selections on scroll bar 106. Based thereon, selection listener 66 determines the position of scroll bar 106. Based on the position, breakpoint setting system 62 can reset breakpoints accordingly. When the position of scroll bar 106 is adjusted automatically the position can be determined from the content. Specifically, the top index of the expandable view 102 is same as position of the scroll bar 106 such that this index can be used as the value of the position of scroll bar 106. To this extent, content listener 68 (FIG. 3) is provided to determine the position of scroll bar 106 based on the top index. Based on the determined position, breakpoint setting system 62 can reset the breakpoints accordingly.

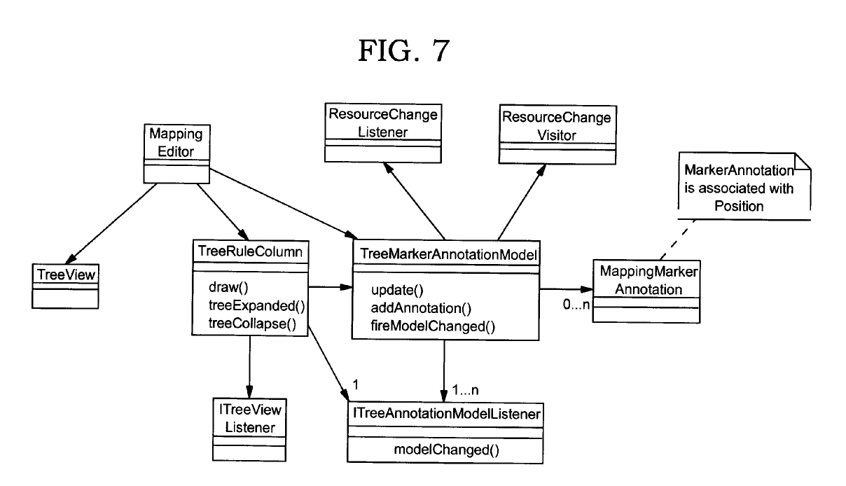

It should be appreciated that although breakpoint setting system 62 has been described as performing all setting and resetting operations, this need not be the case. For example, once a breakpoint is set, any resetting due to view manipulation, or due to scroll bar 106 adjustment can be performed by the respective listeners 64, 66, and 68. In any event, referring to FIG. 7, a UML diagram for implementing these teachings is shown.

B. Identifier System

Under the present invention, identifier system 42 (FIG. 3) is provided to assign unique model identifiers to each model object and any associated breakpoint. Specifically, the model object identifier is used to identify the unique model object in the model. For example, the MOF (Meta-Object Facility) model uses a XMI (XML Metadata Interchange) identifier. The XMI identifier is the default serialization format used by the Eclipse Model Framework (“EMF”) on which the mapping model is based.

The mapping model used by WBIMB is designed to be a general purpose mapping model and it is based on the EMF model. In this mapping model, the model object identifier is needed for the mapping debugging similar to a line number being needed for source code debugging.

Under the present invention, the relative path of the model object could be used as the mapping model object identifier. However, the relative path is usually a string. To be able to integrate with other source debuggers (e.g., Java source debugger), and to be able to leverage the function of the source debugger, an integer is used as the model object identifier under the present invention. The integer is the same as the type of the line number in the source debugger, so that the mapping debugger can be designed by following the JSR45 (Debugging Support for Other Languages) mechanism. JSR45 has defined the Source Map (SMAP), which describes a mapping between source positions in an input language (such as maps) and source positions in a generated output language (such as Java or ESQL). In SMAP, both positions are defined as integers. Therefore, with the integer type of mapping model object identifier, it is easier for a mapping debugger to generate the SMAP.

To be able to assign a numerical integer to each node/model object, a model listener 70 and a model walker 72 are provided for the mapping model. Model listener 70 listens to the change of the mapping model while the model walker 72 walks the hierarchical structure (e.g., tree) in a depth first manner to assign a number to each node/model object.

Each map model has a model listener 70 (one map file has one map model) and every map object has a reference to the model listener 70. The model listener 70 listens to the event of change in the expandable view 102 (FIG. 5). For example, if a model object “B” is added to its parent node/model object “A,” (e.g., via drag and drop techniques) model listener 70 is notified, which adds itself (the model listener 70) to the new node/model object “B” as a reference. Model listener 70 then invokes model walker 72 to “walk” the hierarchical structure to update the number of each node/model object (FIG. 6).

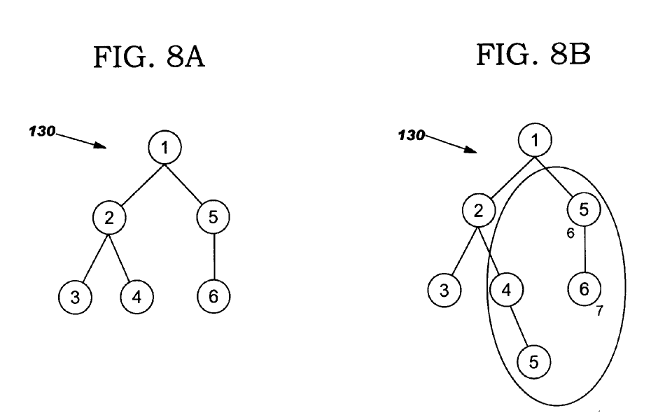

The model walker 72 is responsible for assigning a number to model objects. When the mapping editor is opened or created, the model walker walks the mapping model tree in a depth first manner to assign a number starting from 1. Referring to FIG. 8A, this concept is demonstrated in further detail. Specifically, FIG. 8A depicts an illustrative hierarchical structure 130 that corresponds to an expandable view (i.e., as indicated above, each expandable view can be thought of as a hierarchical structure such as a tree in which each node represents one model object). To this extent, nodes 1-6 each represent a model object in a corresponding expandable view. As the expandable view is being created or modified (e.g., as a user is dragging and dropping model objects into the expandable view), model listener 70 will detect the changes and invoke model walker 72, which will update the model identifiers for each node/model object.

Whenever a child is added to or removed from hierarchical structure 130, the model walker 72 will be triggered to walk through the structure 130. To improve the performance of visiting the hierarchical structure 130, the model walker 72 will only walk the sub-tree of the added node/model object as well as the non-related parts of the hierarchical structure to re-assign the model identifiers. As shown in FIG. 8B, a child node/model object has been added hierarchically below node/model object “4.” As such, model walker 72 assigned the model identifier of “5” to the new node/model object, and then walked the other non-related part (e.g., nodes/model objects 5-6) of hierarchical structure 130 to reassign the model identifiers as shown. To this extent, node/model objects “5” and “6” of FIG. 8A have been reassigned the model identifiers of “6” and “7” as depicted in FIG. 8B.

Under the present invention, the model object identifiers are also used as attributes or breakpoint identifiers for corresponding breakpoints. For example, if a node/model is assigned the model identifier of “5,” any breakpoint set for the node/model object in the corresponding expandable view will be assigned a breakpoint identifier of “5” (e.g., by model walker 72 or breakpoint setting system 62).

C. Recovery System

As shown in FIG. 3, mapping system 38 also includes recovery system 44, which contains object deletion system 80 and object addition system 82. In general, recovery system 44 allows breakpoints to be recovered when a previously deleted node/model object is subsequently re-added to the expandable view/hierarchical structure. As described above, model walker 72 (FIG. 3) is triggered to update model object identifiers whenever a node/model object is added or deleted. Moreover, the map command that a model object represents in the model could be associated with a breakpoint has been set. Since the model object identifier is changed, the corresponding breakpoint identifier for that map command will also change.

In many instances, when a model object is added, the map model does not always simply add a new node/model object to its parent. Sometimes, it might delete all the children of the parent node/object, recreate the children and the newly added node/object, then group children (including the newly added child) together and add them to the parent node/object (one reason for doing this is for performance concerns). This raises a problem for the mapping debugger. For example, assume user 24 (FIG. 2) wishes to add a new node/model object “E” to a parent “A.” Further, assume that the map model deletes all existing children of “A” (“B”, “C”, “D” are the children of “A”), recreates them with the new object “E,” and then adds all four children to “A” at once. However, if child “B” had a breakpoint when it was deleted, the deletion of child “B” means that the breakpoint on “B” will also be deleted. Since user 24 did not control or request deletion of this breakpoint, user 24 may be unaware that the breakpoint was deleted when the node/model object was deleted. As such, recovery system 44 provides a mechanism to recover this deleted breakpoint when child “B” is re-added (e.g., at the time of adding all children back to the parent “A”).

To this extent, the present invention provides a breakpoint information cache (cache 52 in FIG. 2) for recovering breakpoints. Thus, when user 24 (FIG. 2) deletes node/model object that has a breakpoint associated with it, breakpoint information on that node/model object will be stored in cache 52 by object deletion system 80 before the breakpoint is deleted. As will be further described below, caching this breakpoint information helps to recover the deleted map object with a breakpoint if the node/model object is subsequently re-added.

Before the algorithms of the present invention for deleting and re-adding (i.e., recovering) a node/model object are discussed, the basic structure of a node/model object is as follows. Specifically, each node/model object in this mapping model, which is generally based on the EMF model, has two integer fields: startOffset and stopOffset. The startOffset field is for storing a new or current model object identifier while the stopOffset field is for storing an old model object identifier. An old map object identifier is a model object identifier of a deleted node/model object. As will be further described below, breakpoint cache 52 and the stopOffset field will be used to identify a newly added node/model object as a previously deleted node/model object identifying the new node's status.

Under the present invention, the following steps are carried out by object deletion system 80 whenever a node/model object is deleted. It should be understood that in these steps, it is assumed that node “B” is being deleted and re-added. This is done for illustrative purposes only.

(1) Determine if node “B” has a breakpoint. To make this determination, object deletion system 80 will obtain node “B”'s model object identifier. If a breakpoint in the list 50 (FIGS. 2-3) has the same model identifier and the same file name, then node “B” has a breakpoint.

(2) If node “B” has a breakpoint, object deletion system 80 will store the breakpoint information (e.g., identifier and file name) in cache 52 and then remove the breakpoint from the vertical ruler 108.

(3) If node “B” does not have a breakpoint, object deletion system 80 will signal identifier system 42 to update the breakpoint identifiers after the node “B” (e.g., updating breakpoint identifiers when an identifier is greater than node “B”'s model object identifier).

When a new map object is added, from the user's point of view, there is no change except for adding a new node, while the map model treats all added nodes as new nodes (e.g., even the content of the new model object is the same as the deleted one, but there are different objects). Therefore, the present invention will determine if a newly added node is a previously deleted node. If so, it will recover the breakpoint. In this case, the map model object identifier will be used to determine if the newly added node and a previously deleted node are in fact the same node. Specifically, if a new node is added, object addition system 82 (FIG. 3) will perform the following steps (again assuming that node “B” is being added for illustrative purposes only).

(1) Determine if new node “B” is the old “B” that has been deleted earlier and if it had a breakpoint. To accomplish this, object addition system 82 will examine the second field of the new node “B.” If this value is a negative value such as −1, then it is a new node. However, if this value is greater than 0, then it was a previously deleted node that is now being re-added. In such a case, object addition system 82 will compare the stopOffset field in the new node “B” with cache 52. If there is an item whose identifier matches the value in the stopOffset field, then this deleted node (now being added back) had a breakpoint previously.

(2) If this is the case, a breakpoint for node “B” will be added (e.g., by recovery system 44 (FIG. 3)), and the entry for old node “B” will be removed from cache 52 by object addition system 82.

(3) However, if this is not the case, the breakpoints after node “B” will be updated as indicated above (e.g., updating breakpoint identifier when an identifier is greater than the node “B”'s model object identifier).

Once the new model object has been added, regardless of whether it was previously deleted, it will be assigned a new model object identifier. This value will be stored in the startOffset field of the new model object, and then assigned to the breakpoint as a breakpoint identifier.

It should be appreciated that the present invention could be offered as a business method on a subscription or fee basis. For example, computer system 22 and/or mapping system 38 could be created, supported, maintained and/or deployed by a service provider that offers the functions described herein for customers. That is, a service provider could offer to set and/or manage breakpoints as discussed herein for customers.

Still yet, it should be understood that the present invention could be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, a particular configuration of sub-systems is depicted within mapping system 38 for illustrative purposes only. To this extent, the functions thereof could be carried out by a different configuration.

What is claimed is:

1. A data schema mapping editor comprising:
an expandable view of model objects, wherein each of the model objects corresponds to a unit of source code; and
a vertical ruler associated with the expandable view for setting breakpoints for the model objects.

2. The data schema mapping editor of claim 1, wherein the expandable view is a hierarchical structure, and wherein the model objects represent nodes in the hierarchical structure.

3. The data schema mapping editor of claim 2, wherein each of the model objects and their corresponding nodes are assigned a unique identifier.

4. The data schema mapping editor of claim 1, further comprising a scroll bar for browsing the expandable view.

5. The data schema mapping editor of claim 4, wherein the breakpoints are reset based on a manipulation of the expandable view or an adjustment of the scroll bar.

6. The data schema mapping editor of claim 1, wherein the expandable view comprises a tree view.

7. The data schema mapping editor of claim 1, wherein the expandable view comprises a table tree view.

8. A system for setting breakpoints in a data schema mapping editor, comprising:
a breakpoint setting system for setting the breakpoints along a vertical ruler associated with an expandable view of model objects in the data schema mapping editor;
a view listener for resetting the breakpoints based on a manipulation of the expandable view;
a selection listener for resetting the breakpoints based on a manual adjustment of a scroll bar associated with the expandable view; and
a content listener for resetting the breakpoints based on an automatic adjustment of the scroll bar.

9. The system of claim 8, further comprising:
a model listener for detecting changes in the expandable view; and
a model walker for assigning identifiers to the model objects in the expandable view based on the changes detected by the model listener.

10. The system of claim 9, wherein the changes comprise adding a model object to the expandable view or deleting a model object from the expandable view.

11. The system of claim 8, wherein the expandable view is a hierarchical structure, wherein the model objects represent nodes in the hierarchical structure.

12. The system of claim 8, further comprising a recovery system for determining whether a new model object is a previously deleted model object, and for recovering a breakpoint if the new model object is determined to be the previously deleted model object.

13. The system of claim 12, wherein the recovery system:
determines whether a model object to be deleted has the breakpoint; and
if the model object to be deleted has the breakpoint, stores information corresponding to the breakpoint in a cache, and stores an identifier assigned to the breakpoint in a predetermined field of the model object to be added.

14. The system of claim 8, wherein the manipulation of the expandable view comprises an expansion or a collapsing of the expandable view.

15. The system of claim 8, further comprising a ruler system for generating the vertical ruler.

16. A program product stored on a recordable medium for setting breakpoints in a data schema mapping editor, which when executed, comprises:
program code for setting breakpoints along a vertical ruler associated with an expandable view of model objects in a data schema mapping editor;
program code for resetting the breakpoints based on a manipulation of the expandable view;
program code for resetting the breakpoints based on a manual adjustment of a scroll bar associated with the expandable view; and
program code for resetting the breakpoints based on an automatic adjustment of the scroll bar.

17. The program product of claim 16, further comprising:
program code for detecting changes in the expandable view; and
program code for assigning identifiers to model objects of the expandable view based on the changes detected by the model listener.

18. The program product of claim 17, wherein the changes comprise adding a model object to the expandable view or deleting a model object from the expandable view.

19. The program product of claim 16, wherein the expandable view is a hierarchical structure, wherein the model objects represent nodes in the hierarchical structure.

20. The program product of claim 16, further comprising program code for determining whether a new model object is a previously deleted model object, and for recovering a breakpoint if the new model object is the previously deleted model object.

21. The program product of claim 20, wherein the program code for determining:
determines whether a model object to be deleted has the breakpoint; and
if the model object to be deleted has the breakpoint, stores information corresponding to the breakpoint in a cache, and stores an identifier assigned to the breakpoint in a predetermined field of the model object to be added.

22. The program product of claim 16, wherein the manipulation of the expandable view comprises an expansion or a collapsing of the expandable view.

23. The program product of claim 16, further comprising program code for generating the vertical ruler.

24. A method for recovering breakpoints in a data schema mapping editor, comprising:
receiving a command to delete a model object from an expandable view in the data schema mapping editor;
determining whether the model object has a breakpoint on a vertical ruler associated with the expandable view; and
if the model object has the breakpoint, storing information corresponding to the breakpoint in a cache, storing an identifier associated with the breakpoint in a predetermined field of the model object, and deleting the breakpoint from the vertical ruler.

25. The method of claim 24, wherein the expandable view comprises a hierarchical structure in which the model objects represent nodes, and wherein the method further comprises updating any identifiers associated with model objects hierarchically below the model object if the breakpoint does not exist.

26. The method of claim 24, further comprising:
receiving a command to add a new model object to the expandable view;
determining whether the new model object is the model object for which the command to delete was received by comparing a value in the predetermined field of the new model object to the information stored in cache; and
removing the information from the cache if the new model object is the model object for which the command to delete was received.

27. The method of claim 24, further comprising:
adding the new model object; and
setting the breakpoint for the new model object if the new model object is the model object for which the command to delete was received.

28. A system for recovering breakpoints in a data schema mapping editor, comprising:
means for receiving a command to delete a model object from an expandable view in the data schema mapping editor;
means for determining whether the model object has a breakpoint on a vertical ruler associated with the expandable view;
means for storing information corresponding to the breakpoint in a cache, and for storing an identifier associated with the breakpoint in a predetermined field of the model object if the model object has the breakpoint; and
means for deleting the breakpoint from the vertical ruler.

29. The system of claim 28, wherein the expandable view comprises a hierarchical structure in which the model objects represent nodes, and wherein the system further comprises means for updating any identifiers associated with model objects hierarchically below the model object if the breakpoint does not exist.

30. The system of claim 28, further comprising:
means for receiving a command to add a new model object to the expandable view;
means for determining whether the new model object is the model object for which the command to delete was received by comparing a value in the predetermined field of the new model object to the information stored in cache; and
means for removing the information from the cache if the new model object is the model object for which the command to delete was received.

31. The system of claim 28, further comprising:
means for adding the new model object; and
means for setting the breakpoint for the new model object if the new model object is the model object for which the command to delete was received.
